(19) United States
(12) Patent Application Publication
(10) Pub. No.: US 2026/0233707 A1
(43) Pub. Date: Aug. 13, 2026

(54) SYSTEM FOR SPRAYING A LIQUID ONTO AN OPTICAL SURFACE

(71) Applicant: VALEO SYSTEMES D'ESSUYAGE, LE MESNIL SAINT DENIS (FR)

(72) Inventor: Cyrille GIRODOT, La Verriere (FR)

(73) Assignee: VALEO SYSTEMES D'ESSUYAGE, La Verriere (FR)

(21) Appl. No.: 19/155,598

(22) PCT Filed: Feb. 9, 2024
(86) PCT No.: PCT/EP2024/053396

§ 371 Date: Aug. 12, 2025

(30) Foreign Application Priority Data
Feb. 17, 2023 (FR) 2301507

(51) Int. Cl. B60S 1/52; B08B 3/02; B08B 5/02; G02B 27/00

(52) U.S. Cl. CPC B60S 1/52; B08B 3/02; B08B 5/02; G02B 27/0006; B08B 2203/02

(57) ABSTRACT

The invention relates to a system for spraying a washing fluid onto an optical surface. The spraying system includes a cavity delimited by a base and by a cover, a spraying device designed to spray the washing fluid formed of a mixture of air and liquid onto the optical surface, an opening arranged at a low point in the cavity for discharging excess liquid in the cavity out of the cavity, in particular outside the phases of use of the spraying system, and a member for blocking the opening designed to (i) obstruct the opening when there is no liquid in the cavity, and (ii) allow the liquid to be discharged through the opening when there is liquid in the cavity.

### TECHNICAL FIELD

The technical context of the present invention is that of cleaning of optical surfaces, in particular of the type found facing sensors embedded in a motor vehicle or associated with lighting and/or signaling devices. More particularly, the invention relates to a system for spraying a liquid onto an optical surface.

### BACKGROUND OF THE INVENTION

In the prior art, many devices allowing dirt present on glazed surfaces or on optical surfaces to be removed are known. Such dirt for example takes the form of dust, of particles of dried mud or of fatty films. This dirt, when it is present on an optical surface, prevents an observer from getting a satisfactory view of her or his surroundings through the optical surface or prevents correct operation of a sensor configured to emit or receive radiation through the optical surface.

In order to clean dirt accumulated on a motor-vehicle windshield, it is known to spray a cleaning liquid onto the windshield, and then to spread said sprayed cleaning liquid via a reciprocating movement of one or more windshield wipers applied to the windshield. The friction of the wipers on the windshield allows the dirt dispersed in the cleaning liquid to be removed from the optical surface.

In the field of cleaning assemblies applied to sensors embedded in a motor vehicle or to the lighting and/or signaling devices thereof, it is known to use a system for spraying a fluid onto the optical surface. The spraying system may spray cleaning liquid, air or indeed cleaning liquid and air simultaneously in order to form a pressurized sheet that is sprayed onto the optical surface, thus contributing to better removal of the dirt present on the optical surface.

In such known cleaning assemblies, it is possible for liquid, either cleaning liquid if the spraying system comprises a liquid nozzle or indeed rainwater, to penetrate into the spraying system, or for example into the compressed air nozzle. This undesired introduction of water or cleaning liquid into the spraying system and in particular into the compressed air nozzle may lead to a malfunction of such known cleaning assemblies. This is because the presence of water or cleaning liquid in the compressed air nozzle, or in an air circuit of such known cleaning assemblies, may lead to an increase in compressed air flow rate-due to the presence of water or cleaning liquid in the circuit, then leading to excessive spraying onto the glazed surface.

### SUMMARY OF THE INVENTION

One aim of the present invention is to provide a new system for spraying a cleaning fluid, in order to at least partly address the above problems and, furthermore, to achieve other advantages.

Another aim of the invention is to make the operation of such a spraying system more reliable and robust.

Another aim of the invention is to achieve better removal of undesirable liquid from such a spraying system, without human intervention.

Another aim of the invention is to reduce the risk of failure and the frequency of maintenance operations.

Another aim of the invention is to decrease the cost of such a spraying system.

According to a first aspect of the invention, at least one of the abovementioned aims is achieved by means of a system for spraying a fluid onto an optical surface, the spraying system comprising:
a cavity bounded by a base and by a cover;
an inlet for fluid, intended to place a supply line in fluid communication with the cavity;
a spraying device configured so as to be able to spray the fluid onto the optical surface;
an orifice formed at a low point of the cavity;
a member for obstructing the orifice, configured to (i) obstruct the orifice if liquid is absent from the cavity, the obstructing member then being configured in a closed position, and (ii) permit removal of liquid through the orifice, if liquid is present in the cavity, the obstructing member then being configured in an open position.

For example, the fluid is air. For example, the spraying device is an air nozzle.

According to one aspect, the spraying system comprises an inlet for a second fluid, intended to place a supply line in fluidic communication with the cavity (120), the second fluid being different from the fluid called the first fluid.

For example, the second fluid is a cleaning liquid.

In the context of the present invention, the spraying system is configured to be able to spray the fluid onto the optical surface. The spraying system comprises a spraying system that may, for example, allow the cleaning fluid to be nebulized, or a mist of the cleaning fluid to be formed, or the liquid to be accelerated and shaped into a sheet of cleaning fluid able to be applied to the optical surface. Generally, the spraying system may mix the liquid and air to form the cleaning fluid that is then sprayed onto the optical surface

In the context of the present invention, the cavity forms a concave surface permitting temporary retention of liquid. The cavity in particular makes it easier to bring together the air and liquid used to form the cleaning fluid. In the context of the invention, the base and the cover together bound a hollow chamber, one portion of said chamber forming the cavity. The cavity is preferably associated with the base, i.e. formed in or by the base itself. The base for example comprises peripheral rims that protrude with respect to a bottom surface, thus forming the cavity. Advantageously, the base and cover are attached and securely fastened to each other, for example by snap-fastening or by any fastening means.

In the context of the present invention, the air inlet forms an aperture opening into the cavity and through which air may be introduced into said cavity. The air is preferably delivered via an air supply line coupled to the cavity—through the air inlet—by a coupling member. In the context of the present invention, the coupling member is configured to permit mechanical and fluid coupling to the air supply line. The air supply line is intended to deliver air to the spraying system according to the invention, via the coupling member. For example, the coupling member comprises a male end-fitting configured to mate with a female end-fitting of the air supply line, or the coupling member comprises a female end-fitting configured to mate with a male end-fitting of the air supply line. The coupling member opens into the cavity. The coupling member is integral with the base or cover of the spraying system according to the invention. The coupling member is integral with the air inlet.

In the context of the present invention, the liquid inlet forms an aperture opening into the cavity and through which a liquid may be introduced into said cavity. The liquid is preferably delivered via a liquid supply line coupled to the cavity—through the liquid inlet—by a coupling element. In the context of the present invention, the coupling element is configured to permit mechanical and fluid coupling to the liquid supply line. The liquid supply line is intended to deliver said liquid to the spraying system according to the invention, via the coupling element. For example, the coupling element comprises a male end-fitting configured to mate with a female end-fitting of the liquid supply line, or the coupling element comprises a female end-fitting configured to mate with a male end-fitting of the liquid supply line. The coupling element opens into the cavity. The coupling element is integral with the base or cover of the spraying system according to the invention. The coupling element is integral with the liquid inlet.

In the context of the present invention, the low point is a region of the cavity, and more particularly of the base for example, toward which a liquid placed at any point in the cavity flows. The low point is thus formed by the region of the cavity placed lowest relative to a vertical axis, in the given orientation of the spraying system when said spraying system is mounted on the motor vehicle it is intended to equip. The low point is of course dependent on an orientation of the spraying system according to the invention on the motor vehicle which it is intended to equip. By way of non-limiting example, the low point may be located in proximity to—or even against—a peripheral edge of the base or cover, or in a corner of the base or cover.

In the context of the present invention, the orifice takes the form of a hole opening onto either side of the cavity, i.e. the base and/or the cover. The orifice is preferably oriented in such a way that the liquid is able to flow through said orifice and to an outlet face located outside the cavity via simple gravity flow.

In the context of the present invention, the obstructing member allows, depending on its configuration, the orifice to be blocked or cleared. The obstructing member thus makes it possible to permit or prevent a flow of liquid through the orifice, depending on its configuration. In the context of the invention, the obstructing member switches from its closed position to its open position without human intervention and, preferably, without electronic control.

In the context of the present invention, the liquid is preferably water or contains water. Generally, the liquid is the type of cleaning liquid usually used in the automotive field to clean optical surfaces.

Thus, the reliability and robustness of the operation of the spraying system according to the first aspect of the invention is increased because provision is made, at a lower cost, for better removal of temporarily stagnant liquid from the cavity of such a spraying system, without human intervention.

Consequently, the spraying system according to the first aspect of the invention allows the risk of failure and the frequency of maintenance operations to be decreased.

The spraying system according to the first aspect of the invention advantageously comprises at least one of the following refinements, the technical features forming these refinements being able to be implemented alone or in combination:
the member for obstructing the orifice takes the form of a float plug configured to be able to float on the liquid if liquid is present in the cavity. This advantageous configuration allows access to the orifice to be automatically cleared in order to permit the liquid present in the cavity to flow through the orifice and thus allow automatic and spontaneous removal of said liquid from the cavity.
for this purpose, the obstructing member has a mass per unit volume less than the mass per unit volume of the liquid. In the case where the liquid is water, a density of the obstructing member is less than 1. By way of non-limiting example, the obstructing member is formed from one or more materials in particular selected from plastics, polystyrenes and different types of wood, so that a mass per unit volume of said obstructing member is less than the mass per unit volume of water;
the orifice is bounded by a countersink forming an inclined, or even conical, surface complementary to the shape of the obstructing member. In other words, a peripheral outline of the obstructing member is complementary or analogous or identical to one portion of the countersink, so as to allow complementary shapes of said countersink and said obstructing member to mate;
preferably, the obstructing member has a spherical or conical shape. At the very least, an end of the obstructing member proximal to the cavity orifice located opposite has a spherical or conical shape in order to facilitate occlusion of said cavity when the obstructing member is configured in its closed position. This advantageous configuration allows a peripheral outline of the obstructing member to be permitted to collaborate more easily and in a complementary manner with an analogous shape of the orifice formed in the cavity, thus allowing the cavity to be effectively obstructed;
the obstructing member comprises a retaining device configured to hold said obstructing member in proximity to the orifice. By proximity, what is meant is that the retaining device allows the obstructing member to be held in the direct vicinity of the orifice, so that said obstructing member may collaborate again, easily and quickly, with the orifice in the event of future appearance of fluid in the cavity;
preferably, the retaining device is configured to hold the obstructing member coaxial with respect to the orifice formed in the cavity. In other words, the retaining device is configured on the one hand to axially center the obstructing member on the orifice, and on the other hand to permit a coaxial movement of the obstructing member with respect to the orifice from the closed position to the open position;
the retaining device comprises an apertured cage housing the obstructing member, the apertured cage permitting a movement of the obstructing member in said apertured cage and plumb with the cavity. By apertured cage, what is meant is that peripheral walls of the apertured cage are not solid. On the contrary, the peripheral walls bounding the apertured cage and inside of which the obstructing member is held comprise at least one aperture so as to permit fluid to flow through said at least one aperture;
advantageously, the apertured cage forming the retaining device extends between the base and cover of the cavity;
the orifice is located in proximity to the fluid inlet (e.g. the air inlet) and away from the spraying device. In other words, the air inlet is located in proximity to the low point of the cavity, while the spraying device is located away from the low point of said cavity. A distance between the fluid inlet and the low point is therefore less than a distance measured between the spraying device and said low point;
the base comprises a groove formed between the spraying device and the liquid inlet, the groove being oriented toward the orifice. In other words, a direction and/or slope of the groove is oriented toward the orifice and the low point of the cavity, so as to permit gravity flow of the liquid contained in the cavity toward said orifice. This advantageous configuration prevents the liquid present in the cavity from flowing through the liquid inlet and toward the coupling member of the air supply line.

According to a second aspect of the invention, an assembly for cleaning an optical surface is provided, this assembly comprising:
a spraying system according to the first aspect of the invention or according to any of its refinements, the spraying system being configured to be able to spray a fluid onto the optical surface;
an air supply line coupled to the air inlet of the spraying system via a coupling element.

Various embodiments of the invention are provided, these incorporating in all their possible combinations the various optional features described here.

### BRIEF DESCRIPTION OF DRAWINGS

Further features and advantages of the invention will become more clearly apparent, on the one hand, from the following description and, on the other hand, from a plurality of non-limiting examples of embodiment that are given by way of indication with reference to the appended schematic drawings, in which:

FIG. 1 illustrates integration of one example of embodiment of a spraying system according to the first aspect of the invention facing an optical surface to be cleaned;

FIG. 2 illustrates a detailed view of a cover forming the spraying system illustrated in FIG. 1;

FIG. 3 illustrates a first detailed perspective view of the base of the spraying system illustrated in FIG. 1;

FIG. 4 illustrates a second detailed perspective view of the base of the spraying system illustrated in FIG. 1;

FIG. 5 illustrates a schematic and sectional view of a member for obstructing the orifice present in the cavity of the spraying system illustrated in FIG. 1, when said orifice is closed by said obstructing member; and

FIG. 6 illustrates a schematic and sectional view of a member for obstructing the orifice present in the cavity of the spraying system illustrated in FIG. 1, when said orifice is left open by said obstructing member.

### DETAILED DESCRIPTION OF THE INVENTION

Of course, the features, the variants and the various embodiments of the invention may be associated with one another, in various combinations, provided that they are not mutually incompatible or exclusive. It is possible in particular to imagine variants of the invention that comprise only a selection of the features described below independently of the other described features, if this selection of features is enough to impart a technical advantage or to distinguish the invention from the prior art.

In particular, all the variants and all the embodiments that are described may be combined with one another if nothing prevents this combination from a technical perspective.

In the figures, elements that are common to multiple figures keep the same reference.

With reference to FIG. 1 to FIG. 6, the invention relates to a system 1 for spraying a cleaning fluid onto an optical surface 19, the spraying system 1 comprising, in this example of embodiment:
a cavity 120 bounded by a base 12 and by a cover 11;
a member 13 for coupling to an air supply line 15, the coupling member 13 placing the air supply line 15 in fluidic communication with the cavity 120;
an air inlet 1251 into which the coupling member 13 of the air supply line 15 opens;
an element 20 for coupling to a liquid supply line 15, the coupling element 20 placing the liquid supply line 15 in fluidic communication with the cavity 120;
a liquid inlet 1241 into which the coupling element 20 of the liquid supply line 15 opens;
a spraying device 14 configured to be able to spray the cleaning fluid formed by a mixture of air and liquid onto the optical surface 19;
an orifice 123 formed at a low point of the cavity 120;
a member 16 for obstructing the orifice 123, configured to (i) obstruct the orifice 123 if liquid is absent from the cavity 120, the obstructing member 16 then being configured in a closed position, and (ii) permit removal of the liquid 18 through the orifice 123, if liquid is present in the cavity 120, the obstructing member 16 then being configured in an open position.

The optical surface 19 may be plane or curved, and oriented in any direction. The spraying system 1 is placed in direct proximity to the optical surface 19 to be cleaned, facing the latter. Of course, in order not to be placed directly facing the optical surface 19 so as not to impede operation of any sensor or device placed behind the optical surface 19, the spraying system 1 is preferably placed on a peripheral edge 122 of the optical surface 19, so that the sprayed cleaning fluid reaches the optical surface 19.

Thus, the spraying system 1 allows the cleaning fluid to be effectively sprayed onto the optical surface 19. The spraying system 1 is a spraying system allowing the cleaning fluid to be nebulized, or a mist of the cleaning fluid to be formed, or the liquid to be accelerated and shaped into a sheet of cleaning fluid able to be applied to the optical surface 19. Generally, the spraying system 1 mixes a liquid and air to form the cleaning fluid that is then sprayed onto the optical surface 19.

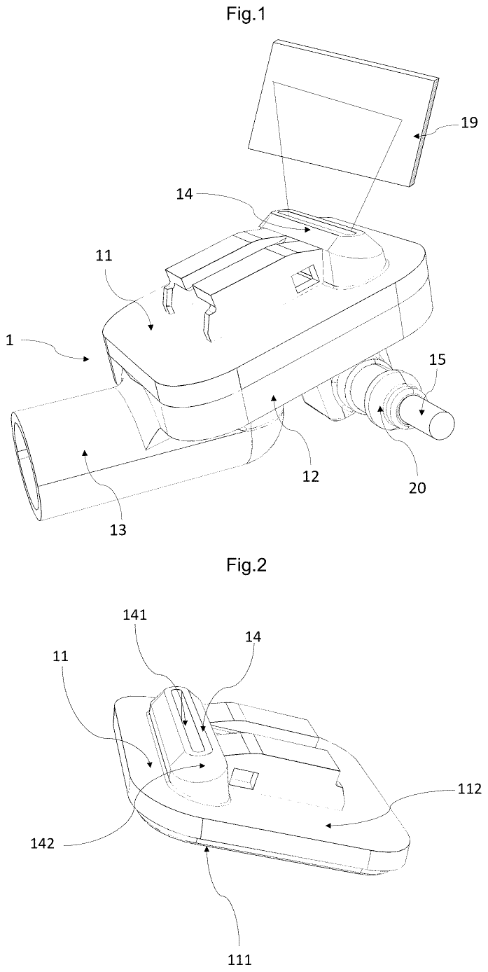

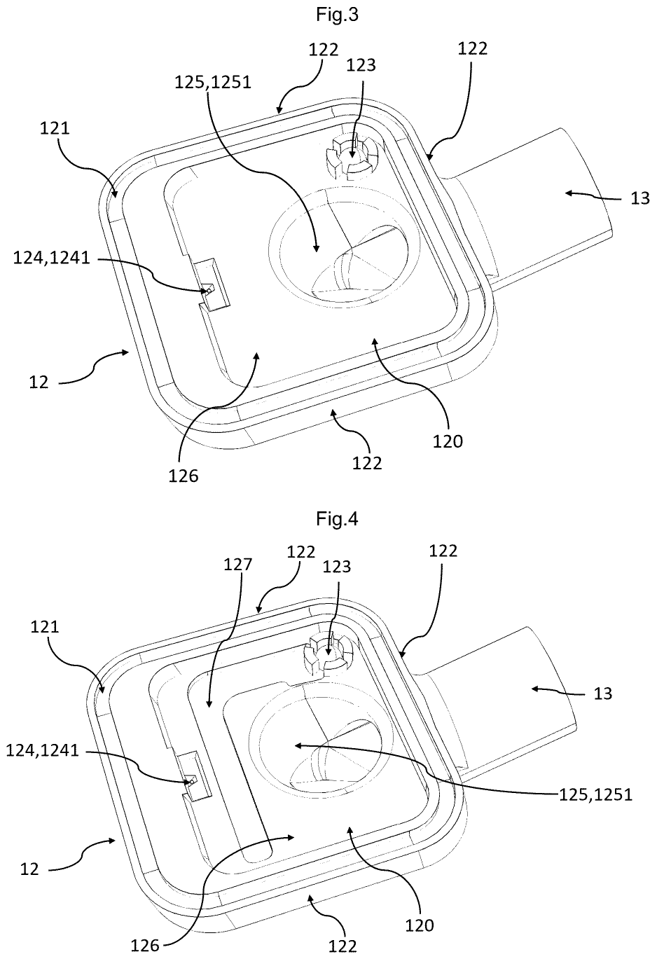

As may be seen in the example of embodiment illustrated in FIG. 2 to FIG. 3, the spraying system 1 is mainly formed from two main parts that are joined together in order to form the cavity 120 used to mix the liquid and air to form the cleaning fluid:
the cover 11, shown in FIG. 2, and
the base 12, shown in FIG. 3 and FIG. 4.

The cover 11 takes the form of a closing part that allows the base 12 to be completely covered. The cover 11 is thus placed in abutment against the peripheral walls 171 of the base 12. In order to facilitate assembly and to allow a joint that is seal-tight with regard to the operation of the spraying system 1, the cover 11 comprises a peripheral curb 111 that extends all the way around said cover 11, and the base 12 comprises a peripheral groove 121 that extends the length of the peripheral walls 171. The dimensions, shapes and location of the curb 111 and of the peripheral groove 121 make it possible, when the cover 11 is assembled on the base 12, to engage the curb 111 in the peripheral groove 121. This advantageous configuration allows the cover 11 and base 12 to be centered, and also contributes to a complementarity in shape that leads to seal-tightness.

Cleverly, an O-ring may be placed in the groove or on the curb 111 in order to optimize the seal-tight connection between the cover 11 and the base 12. The cover 11 and the base 12 may be joined to each other using a mounting process that ensures a seal is formed between these two components, such as adhesive bonding or ultrasonic welding. It could also be envisaged for an O-ring and such a mounting process to be employed in combination.

Of course, the objective here is to allow the spraying system 1 to operate without loss of cleaning fluid in the area of abutment between the cover 11 and base 12.

The spraying device 14 takes the form of a longitudinal slot 141 formed in a protrusion 142 formed in the cover 11. The longitudinal slot 141 has a rectangular shape, and hence the fluid sprayed onto the optical surface 19 takes the form of a comb of great width. Here, what is meant by “great width” is that the width of said comb of cleaning fluid is at least equal to one dimension of the optical surface 19 to be cleaned.

The slot 141 forming the spraying device 14 extends through the cover 11. The slot 141 is formed in the protrusion 142 in such a way that, in the spraying system 1, the cleaning fluid is able to be delivered to the spraying device 14 and to be sprayed onto the optical surface 19 to be cleaned with sufficient pressure. In other words, the spraying device 14 forms a cleaning nozzle.

As mentioned above, the cleaning fluid is formed from a liquid and a flow of compressed air delivered to the cavity 120. Mixed with each other, they form the cleaning fluid that is sprayed out of the cavity 120 via the spraying device 14 and the associated slot 141. An internal geometry of the cavity 120, bounded by the peripheral walls 171 of the base 12, by a bottom wall 126 of the base 12 and by the cover 11, makes it possible to orient the air delivered to the cavity 120 via the air supply line 15 and the liquid delivered to the cavity 120 by the liquid supply line.

In order to allow the liquid and air to be mixed in the cavity 120, each air supply line 15 opens through an aperture 125 into said cavity 120. The aperture 125 thus forms the air inlet 1251. It will be recalled that the liquid is delivered to the cavity 120 by way of a liquid supply line 15 that opens through a window 124 into the cavity and that forms the liquid inlet 1241.

A major technical problem solved by the invention resides in the removal of liquid, water 18 for example, present in the cavity 120 out of said cavity 120, via the orifice 123 formed in one of the walls bounding the cavity 120. The orifice 123 forms a hole opening onto either side of the cavity 120. The orifice 123 is formed in and through the base 12 and/or in and through the cover 11. The orifice 123 is preferably oriented in such a way that the liquid 18 is able to flow through said orifice 123 and out of the cavity 120 via simple gravity flow.

To this end, the orifice 123 is advantageously formed at a low point of the cavity 120. Of course, depending on the orientation of the spraying system 1 according to the invention when it is deployed in front of the optical surface 19 to be cleaned, the low point may be located at any location in said spraying system 1 and in the corresponding cavity 120. In the example of embodiment illustrated in the FIGURES, for a spraying system 1 oriented toward the top of the FIGURES, the low point may for example be located in proximity to a lower right edge of the base 12.

The orifice 123 is located in proximity to the aperture 125 associated with the coupling member 13 of the air supply line 15—forming the air inlet 1251—and away from a window 124—forming the liquid inlet 1241—placing the cavity 120 in communication with the device 14 for spraying the liquid. In other words, the coupling member 13 of the air supply line 15 is located in proximity to the low point of the cavity 120, while the window 124 associated with the device 14 for spraying the liquid is located away from the low point of said cavity 120. In yet other words, the air inlet 1251 is located in proximity to the low point of the cavity 120, while the liquid inlet 1241 is located away from the low point of said cavity 120.

Generally, the low point is the region of the cavity 120—of the base 12 or of the cover 11—toward which the liquid 18 contained at any point in the cavity 120 flows. The low point is thus formed by the region of the cavity 120 placed lowest relative to a vertical axis, in the given orientation of the spraying system 1 when said spraying system 1 is mounted on the motor vehicle it is intended to equip, and hence the liquid 18 is able to flow through the cavity 120, over the base 12 and/or over the cover 11, via simple gravity flow, to said low point.

Optionally, as shown schematically in FIG. 4, the wall bounding the cavity 120 and on which the low point is located, i.e. in which the orifice 123 is formed, comprises a groove 127 a slope of which is oriented toward the orifice 123 in order to drain any liquid 18 that would otherwise be contained in the cavity 120 toward the orifice 123. In this case, particularly advantageously, the groove 127 extends peripherally to the aperture in communication with the air supply line 15, so as to prevent a flow of the liquid 18 into said supply line 15. Thus, the groove 127 follows a rectilinear or curvilinear profile, comprising one or more segments located in the respective extension of a preceding segment, so as to form a channel for flow of the liquid 18 to the orifice 123. The groove 127 is formed in one or more of the walls bounding the cavity 120, depending on the orientation of the spraying system 1 and the location of the low point.

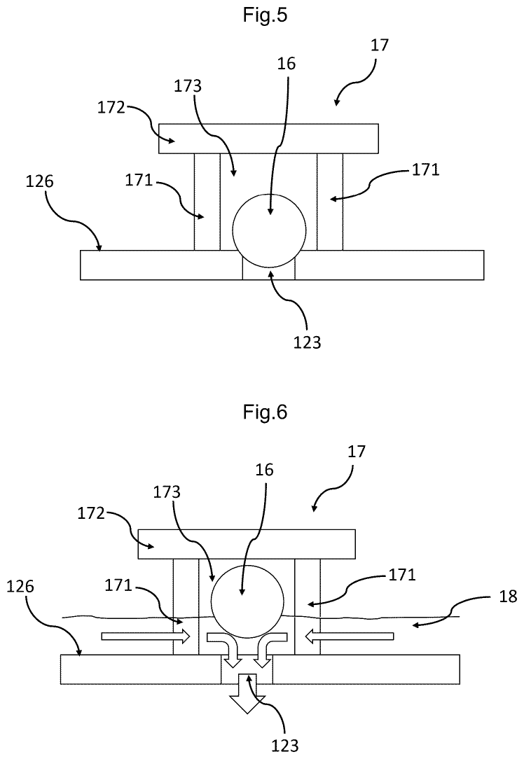

FIGS. 5 and 6 schematically illustrate one example of embodiment of the obstructing member 16 embedded in the spraying system 1 according to the invention. For optimum operation, the obstructing member 16 allows, depending on its configuration, the orifice 123 to be blocked or cleared in order to prevent—as shown in FIG. 5—or permit—as shown in FIG. 6—a flow of liquid 18 through the orifice 123, depending on its configuration, respectively. In the context of the invention, the obstructing member 16 switches from its closed position to its open position without human intervention and, preferably, without electronic control.

In particular, in the example of embodiment illustrated in FIGS. 5 and 6, the obstructing member 16 transitions from its closed configuration—FIG. 5—to its open configuration—FIG. 6—simply through the effect of gravity and of Archimedes' principle if liquid 18 is present in the cavity 120, or at least in proximity to the orifice 123. In the example illustrated, the obstructing member 16 takes the form of a float plug configured to be able to float on the liquid 18 if liquid 18 is present in the cavity 120. In other words, the obstructing member 16 has a mass per unit volume less than the mass per unit volume of the liquid, water 18 for example, i.e. a density of the obstructing member 16 is less than 1. By way of non-limiting example, the obstructing member 16 is formed from one or more materials in particular selected from plastics, polystyrenes and different types of wood, or indeed is a hollow and therefore buoyant body, so that a mass per unit volume of said obstructing member 16 is less than the mass per unit volume of the liquid 18.

Thus, as shown in FIG. 5, if liquid 18 is absent from the cavity 120 and in particular from its low point, then the float plug forming the obstructing member 16 rests on the corresponding wall of the cavity 120, facing the orifice 123. A shape and a dimension of the float plug forming the obstructing member 16 are such that, in this closed configuration, said obstructing member 16 completely obstructs the orifice 123.

In contrast, as shown in FIG. 6, if liquid 18 is present in the cavity 120 and in particular at its low point, then the float plug forming the obstructing member 16 is lifted by the effect of Archimedes' principle out of the corresponding wall of the cavity 120, facing the orifice 123, thus clearing access to said orifice 123 and allowing the liquid 18 to flow therethrough in order to empty the cavity 120 of the liquid 18. The flow of the liquid 18 out of the cavity 120, through the orifice 123, is represented in FIG. 6 by arrows.

This advantageous configuration thus allows access to the orifice 123 to be cleared automatically, without human intervention and without electronic control, i.e. absolutely passively, in order to permit the liquid 18 present in the cavity 120 to flow through the orifice 123 and thus allow automatic and spontaneous removal of the liquid 18 from the cavity 120.

In order to keep the obstructing member 16—and the float plug—facing the orifice 123 and to prevent it from moving away from it due to the flow of liquid 18, the obstructing member 16 comprises a retaining device 17 configured to hold said obstructing member 16 in proximity to the orifice 123. By proximity, what is meant is that the retaining device 17 allows the obstructing member 16 to be held in the direct vicinity of the orifice 123, or even facing said orifice 123, i.e. plumb therewith, so that said obstructing member 16 may collaborate again, easily and quickly, with the orifice 123 in the event of future appearance of the liquid 18 in the cavity 120. Preferably, as shown in FIG. 5 and FIG. 6, the retaining device 17 is configured to hold the obstructing member 16 coaxially with respect to the orifice 123 formed in the cavity 120.

The retaining device 17 comprises an apertured cage forming a housing 173 for the obstructing member 16, the apertured cage permitting a movement of the obstructing member in said apertured cage and plumb with the cavity 120. The apertured cage comprises peripheral walls 171 and an upper wall 172 that surround the obstructing member 16, preferably with clearance. In order to allow the liquid 18 to flow into the apertured cage, the peripheral walls 171 and/or the upper wall 172 are not solid. On the contrary, the peripheral walls 171 and/or the upper wall 172 bounding the apertured cage and inside of which the obstructing member 16 is held contain apertures, not shown in FIG. 5 and FIG. 6.

Alternatively, according to one embodiment (not illustrated), it is also possible to configure the spraying system 1 so that the upper wall 172 is formed, at least partially, by the underside of the cover 11.

In summary, the invention relates to a system 1 for spraying a cleaning fluid onto an optical surface 19, the spraying system 1 comprising a cavity 120 bounded by a base 12 and by a cover 11, a spraying device 14 configured to be able to spray the cleaning fluid formed by a mixture of air and liquid onto the optical surface 19, an orifice 123 formed at a low point of the cavity 120 allowing an excess of liquid present in the cavity 120 to be removed from said cavity 120, in particular outside of phases of use of the spraying system 1, and a member 16 for obstructing the orifice 123 configured to (i) obstruct the orifice 123 if liquid is absent from the cavity 120, and (ii) permit removal of the liquid 18 through the orifice 123, if liquid 18 is present in the cavity 120.

Of course, the invention is not limited to the examples that have just been described, and many modifications may be made to these examples without departing from the scope of the invention. In particular, the various features, forms, variants and embodiments of the invention may be associated with one another, in various combinations, as long as they are not mutually incompatible or exclusive. In particular, all the variants and embodiments described above are combinable with one another.

1. A spraying system for spraying a fluid onto an optical surface, comprising:
a cavity bounded by a base and by a cover;
an inlet for fluid, intended to place a supply line in fluid communication with the cavity;
a spraying device configured so as to be able to spray the fluid onto the optical surface;
an orifice formed at a low point of the cavity;
a member for obstructing the orifice, configured to (i) obstruct the orifice if liquid is absent from the cavity, the obstructing member then being configured in a closed position, and (ii) permit removal of the liquid through the orifice, if liquid is present in the cavity, the obstructing member then being configured in an open position.

2. The spraying system as claimed in claim 1, wherein the obstructing member has a mass per unit volume less than the mass per unit volume of the liquid.

3. The spraying system as claimed in claim 1, wherein the orifice is bounded by a countersink forming a conical surface complementary to the shape of the obstructing member.

4. The spraying system as claimed in claim 1, wherein the obstructing member includes a retaining device configured to hold the obstructing member in proximity to the orifice.

5. The spraying system as claimed in claim 4, wherein the retaining device is configured to hold the obstructing member coaxial with respect to the orifice formed in the cavity.

6. The spraying system as claimed in claim 5, wherein the retaining device includes an apertured cage housing the obstructing member, the apertured cage permitting a movement of the obstructing member in the apertured cage and plumb with the cavity.

7. The spraying system as claimed in claim 1, wherein the orifice is located in proximity to the fluid inlet and away from the spraying device.

8. The spraying system as claimed in claim 1, wherein the base includes a groove formed between the device for spraying fluid and the air inlet, the groove being oriented toward the orifice.

9. The spraying system as claimed in claim 1, further comprising an inlet for a second fluid, intended to place a supply line in fluidic communication with the cavity, the second fluid being different from the fluid called the first fluid.

10. An assembly for cleaning an optical surface comprising:
a spraying system configured to be able to spray a fluid onto the optical surface, the spraying system includes a cavity bounded by a base and by a cover, an inlet for fluid, intended to place a supply line in fluid communication with the cavity, a spraying device configured so as to be able to spray the fluid onto the optical surface, an orifice formed at a low point of the cavity, a member for obstructing the orifice, configured to (i) obstruct the orifice if liquid is absent from the cavity, the obstructing member then being configured in a closed position, and (ii) permit removal of the liquid through the orifice, if liquid is present in the cavity, the obstructing member then being configured in an open position;
an air supply line coupled to an air inlet via a coupling element.
